(19) United States
(12) Patent Application Publication
(10) Pub. No.: US 2018/0022173 A1
(43) Pub. Date: Jan. 25, 2018

(54) Tire Bead Breaking Tool

(71) Applicants: Bosch Automotive Service Solutions Inc., Warren, MI (US); Robert Bosch GmbH, Stuttgart (DE)

(72) Inventors: Robert A. Jensen, Clarks Grove, MN (US); Robert J. Kochie, Dodge Center, MN (US)

(21) Appl. No.: 15/216,431

(22) Filed: Jul. 21, 2016

(51) Int. Cl. B60C 25/01

(52) U.S. Cl. CPC B60C 25/015

(57) ABSTRACT

A tool for breaking a bead of a tire from a wheel rim includes a clamping device and prying device. First and second jaws of the clamping device clamp onto the wheel rim. As the jaws clamp together, the second jaw wedges between the tire and wheel rim, forming a gap therebetween. The second jaw includes a hook that provides a fixed leverage point when the clamping device is fixed in place. The prying device engages with the fixed leverage point, and a wedge disposed on a bend in the prying device is wedged into the gap formed by the clamping device. The prying device is then levered on the fixed leverage point toward the tire so that the wedge pushes on an outer surface of the tire to break the bead of the tire from the wheel rim.

### TECHNICAL FIELD

This disclosure relates generally to automotive tools, and more particularly to tools for removing tires from wheel rims.

### BACKGROUND

Removing a tire from a wheel rim is a common task performed by auto and truck mechanics. Modern tires may be difficult to remove from wheel rims due to increasingly stiff tire side walls which must be flexed in to order for the tires to fit over the wheel rim. The physical connection between a wheel rim and a tire is referred to as a bead, and the process of unseating the tire from the wheel rim is commonly referred to as breaking the bead. Breaking the bead can be difficult, especially when performed manually. In particular, tires and wheel rims for larger vehicles such as trucks or agricultural vehicles are larger, stiffer, and heavier. Large tires also tend to move relative to wheel rims during tire removal, which can interfere with breaking of the bead.

Tools have been developed to address this difficulty. Generally, a bead breaking tool employs a striking action and can include, for example, swinging a traditional hammer or operating a slide hammer in order to drive a wedge between the bead of the tire and the wheel rim. Since hammer tools rely on the accuracy of the user to be effective, using these tools to break the bead of the tire generally involves in a high risk of damaging the tire or wheel rim or injuring the user. Another common problem with using a hammer tool to break the bead of a tire is that the end of the wedge will slip or slide during or between strikes. This can reduce the effectiveness of the tool in breaking the bead, and can result in further risk damaging the wheel rim or tire, and poses a risk of injury to the user. Additionally, using this type of hammer tool and wedge can be mechanically intensive and time consuming.

Therefore, a tire bead breaking tool that decreases the mechanical intensity of breaking the bead of the tire, and decreases the risk of damaging the tire and wheel rim or injuring the user would be beneficial.

### SUMMARY

The following is a brief summary of subject matter described in greater detail herein. This summary is not intended to be limiting as to the scope of this disclosure or to the claims.

In order to facilitate breaking the bead of a tire seated on a wheel rim, a tool according to this disclosure includes a clamping device and a prying device.

The clamping device includes a first jaw and a second jaw. The first jaw has a first plate defining a first face configured to engage an outboard side of a wheel rim and locate the clamping device relative to the wheel rim. The second jaw has a second plate and a hook member. The second plate defines a second face that is transverse to the first face of the first plate and that faces toward an operative end of the clamping device. The second face is configured to engage an outer surface of the tire as the first jaw and second jaw are clamped together so that the second jaw is wedged between the tire and wheel rim. The hook member defines a convex hook facing toward an operative end of the second jaw and is configured to provide a fixed leverage point for the prying device.

The prying device includes an end portion, a bend portion, a grip portion, and a wedge member. The end portion is configured to engage the fixed leverage point on the wheel rim provided by the clamping device. The bend portion extends out from the end portion, and the grip portion is connected to the end portion via the bend portion such that the grip portion is bent away from the tire relative to the end portion when the prying device is engaged on the fixed leverage point. The grip portion defines a grip for levering the prying device on the fixed leverage point. The wedge member is disposed on the bend portion and is configured to wedge between the tire and wheel rim and push against an outer surface of the tire as the grip portion is levered toward the tire.

A method of breaking a bead of a tire seated on a wheel rim according to this disclosure includes clamping the first and second jaws of the clamping device together on the wheel rim in order to fix the clamping device onto the wheel rim. The prying device is engaged onto the fixed leverage point provide by the clamping device. The wedge member of the prying device is wedged between the tire and the wheel rim. The prying device is levered toward the tire so that the wedge portion pushes down against an outer surface of the tire to break the bead of the tire from the wheel rim.

The above presents a simplified summary of this disclosure in order to provide a basic understanding of some aspects of the technologies disclosed herein, and is not an extensive or complete overview of such topics. As such, the summary above does not delineate the scope of this disclosure, and is not intended to identify key or critical aspects of the disclosure. Further details are provided by the detailed description, the claims, and the drawings.

### BRIEF DESCRIPTION OF THE DRAWINGS

FIG. 1 illustrates a perspective view of a tire bead breaking tool according to this disclosure that includes a clamping device and a prying device.

FIG. 2 illustrates a side view of the clamping device from FIG. 1.

FIG. 3 is a top-view image of the clamping device from FIG. 1.

FIG. 4 illustrates a side view of the prying device from FIG. 1.

FIG. 5 is a top-view image of the prying device from FIG. 1.

FIG. 6 is a perspective image of the clamping device of FIG. 1 in use with a tire and wheel rim according to this disclosure.

FIG. 7 illustrates a side detail view of the clamping device in use as in FIG. 6, whereat the clamping device is in an open position.

FIG. 8 illustrates a side detail view of the clamping device of FIG. 7, whereat the clamping device is in a closed position.

FIG. 9 is a perspective image of the prying device of FIG. 1 in use with the clamping device, tire, and wheel rim, according to this disclosure.

FIG. 10 is a flow diagram illustrating an exemplary methodology of breaking the bead of a tire from a wheel rim according to this disclosure.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one of ordinary skill in the art to which this disclosure pertains.

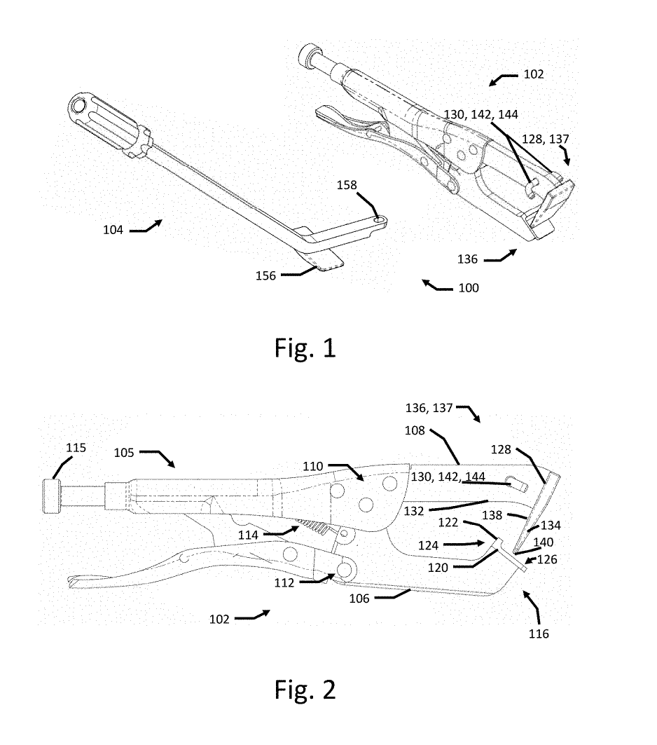

FIG. 1 illustrates a perspective view of an exemplary embodiment of a tool 100 for breaking a bead of a tire from a wheel rim. The tool 100 includes a clamping device 102 and a prying device 104. As discussed in more detail below, the clamping device 102 clamps onto a wheel rim and provides a fixed leverage point, and the prying device 104 engages the fixed leverage point to break the bead of the tire by wedging the tire apart from the wheel rim.

FIG. 2 illustrates a side view of the clamping device 102 from FIG. 1 in a closed position. The clamping device 102 includes a handle portion 105, a first jaw 106 and second jaw 108.

The handle portion 105 includes jaw connection regions 110 and 112 that respectively mount the first jaw 106 and second jaw 108 onto the handle portion 105. In this embodiment, the connection regions 110 and 112 include a plurality of rivets that pivotably connect the jaws 106 and 108 to the handle portion 105, as well as a spring member 114 connected to the first jaw 106. In other embodiments, the connection regions 110 and 112 can include any other acceptable jaw mounting device.

In this embodiment, the clamping device 102 is a pair of locking pliers 102, and the handle portion 105 further includes a locking device 115 that is operable to lock the first jaw 106 and second jaw 108 in place relative to each other. In other embodiments, the clamping device 102 can be any other acceptable type of clamping device, and the handle portion 105 can have any acceptable shape.

The first jaw 106, in an operative end region 116, includes a first plate 120 and a lip 122 extending out from an inside end 124 of the first plate 120.

The first plate 120 defines a first face 126 that faces toward the second jaw 108 and has a width that is greater than a width of the first jaw 106. The first plate 120 is configured to distribute a clamping load of the clamping device 102 over a larger surface area of a wheel rim than would otherwise be contacted by the narrower width of the remainder of the first jaw 106. In this embodiment, the first plate 120 is approximately 1 inch wide, but any acceptable width can be used.

The lip 122 extends out in a direction substantially normal to the first face 126 away from the first jaw 104. The first plate 120 and lip 122 are together configured to engage an outboard side of a wheel rim in order to locate the clamping device 102 relative to the wheel rim.

The second jaw 108 includes a second plate 128 and a hook member 130, and additionally defines an inner surface 132.

The second plate 128 has a width that is greater than a width of the second jaw 108, is oriented substantially transversely to the first plate 120, and defines a second face 134 facing toward an operative end 136 of the clamping device 102, a third face 134 opposite the second face 134, and an end face 140 that faces toward the first plate 120 and connects the second face 134 with the third face 134. The second plate 128 is configured to distribute a clamping load of the clamping device 102 over a larger surface area of a wheel rim and tire than would otherwise be contacted by the narrower width of the remainder of the second jaw 108. In this embodiment, the second plate 128 is approximately 1 inch wide, but any acceptable width can be used.

In this embodiment, the second face 134 and the third face 134 are tapered toward the end face 140, but other geometries are also contemplated in other embodiments. As discussed in further detail below, the second face 134 is configured to engage an outer surface of the tire as the first jaw 106 and second jaw 108 are clamped together so that the second jaw 108 is wedged between the tire and wheel rim.

As illustrated in the perspective view of FIG. 1, the hook member 130 extends laterally out from the second jaw 108. In this embodiment, the hook member 130 extends outward laterally so as to define a convex hook 142 facing toward the operative end 136 of the clamping device 102. In particular, the convex hook 142 is substantially perpendicular to the second plate 128. Other shapes for the hook member 130 are also contemplated in other embodiments. The hook member 130 is configured to provide a fixed leverage point 144 for a prying device, as discussed in further detail below. In this embodiment, the hook member 130 extends out from the second jaw 108 symmetrically, such that the second jaw 108 provides a fixed leverage point on either side of the jaw 108. Extending out in both directions enables engagement with a prying device in either direction, allowing a user to selectively manipulate each of the clamping device 102 and the prying device 104 in either hand, as desired. In other embodiments, the hook member 130 extends only in one direction out from the second jaw 108.

The inner surface 132 extends from the second plate 128 in a direction away from the operative end 136 of the clamping device 102 and faces toward the first jaw 106. In this embodiment, the inner surface 132 defines a convex shape that faces toward an operative end of the second jaw 137, but other shapes for the inner surface 132 are also contemplated in other embodiments. As discussed below, the inner surface 132 is configured to engage an inboard side of the wheel rim to act as a stop 132 that delimits an extent to which the first jaw 106 and second jaw 108 are able to be clamped together.

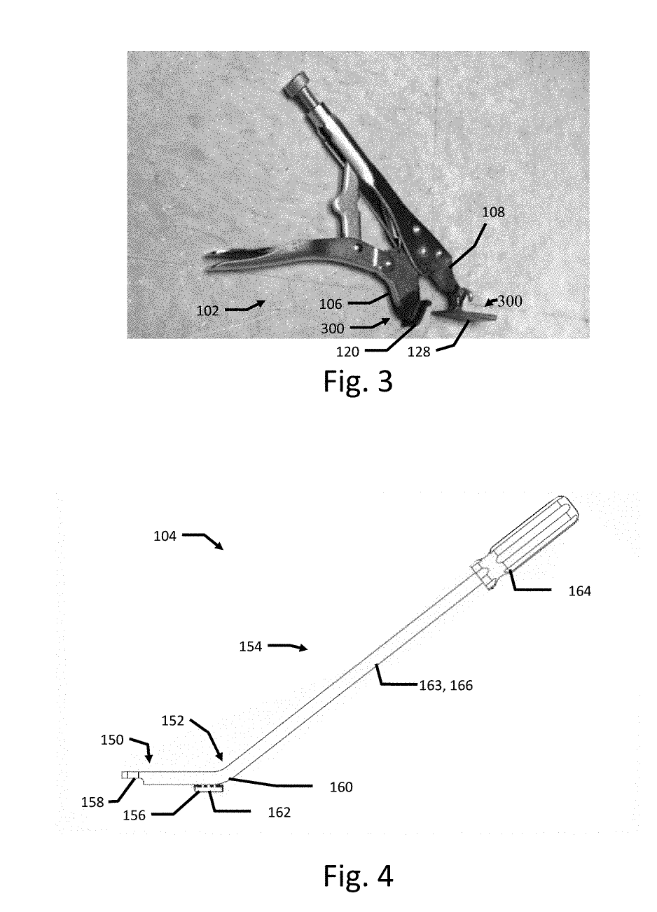

FIG. 3 illustrates an image of the clamping device 102 from FIGS. 1 and 2. The first jaw 106 and second jaw 108 can be formed via any acceptable manufacturing process, such as via a stamping, machining, etc. In one example the first jaw 106 and second jaw 108 are formed by a common stamping process, and the first and second plates 120 and 128 are subsequently disposed onto the first and second jaws 106 and 108 respectively, such as by a weld, bond, bolt, or another acceptable technique. In another embodiment, the plates 120 and 128 are integrally formed with the first and second jaws 106 and 108 respectively. The first jaw 106 and second jaw 108 can be formed from any acceptable material, such as a metal, composite, ceramic, plastic, etc. In this embodiment, the first jaw 104 and second jaw 106 are formed from a metal material such as steel.

In some instances, the high loads involved in a tire unseating process can result in the material of a tire being torn, or material of the wheel rim being scratched, especially when engaged with a relatively narrow surface such as the jaws of conventional pliers. Additionally, the large forces encountered during an unseating operation may cause the jaws of conventional pliers to slide on the surface of the wheel rim, causing the tire to move relative to the wheel rim. Therefore, configuring the jaws 106 and 108 to at least one of deter tearing the tire material, deter scratching the wheel rim, and deter sliding of the jaws 106 and 108 on the wheel rim would be beneficial.

The first and second plates 120 and 128 respectively increase a width of the first and second jaws 106 and 108, respectively in order to distribute the forces over a wider area of the tire and wheel rim and reduce the risks of sliding, tearing, and scratching. Additionally, in this embodiment, at least a portion of the clamping device 102, in particular at least a portion of the first jaw 106 and a portion of the second jaw 108, is coated with a material coating 300 configured to deter at least one of tearing of tire material, scratching of a wheel rim, and sliding of the jaws 106 and 108 on the wheel rim. The material coating 300 can include, for example, a rubber material.

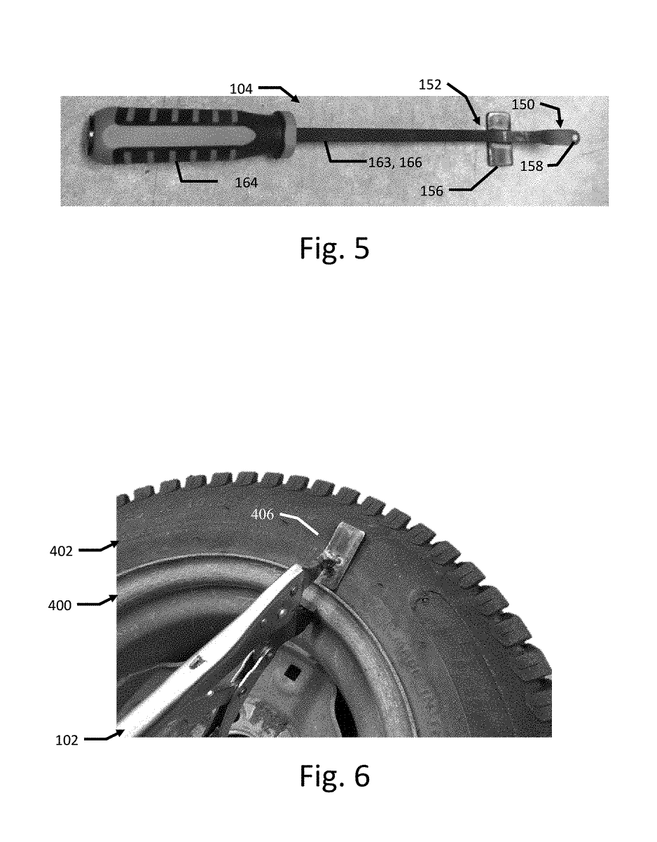

FIG. 4 illustrates a side view of the prying device 104 from FIG. 1, and FIG. 5 is a top view of the prying device 104. The prying device 104 includes an end portion 150, a bend portion 152, a grip portion 154, and a wedge member 156.

The end portion 150 is configured to engage a fixed leverage point on the wheel rim. In particular, the end portion 150 is configured to engage the fixed leverage point 144 provided by the clamping device 102 (FIG. 1). The end portion 150 in this embodiment is approximately 1 to 3 inches long, or more particularly is about 2 inches long.

In this embodiment, the end portion 150 defines a hole 158 that is configured to engage with the hook member 130 of the second jaw 108 of the clamping device 102 such that the hook member 130 is at least partially received in the hole 158. The hole 158 has a substantially rounded cross section (See, e.g., FIG. 1) that is configured to have a running fit with a diameter of the hook member 130.

The grip portion 154 is connected to the end portion 150 via the bend portion 152. The bend portion 152 defines a bend 160 such that when the end portion is engaged to a fixed leverage point on a surface, the grip portion 154 is bent away from that surface. For example, when the end portion 150 of the prying device 104 is engaged with a fixed leverage point on the wheel rim, the grip portion 154 is bent away from an outer surface of a tire mounted on the wheel rim. In this embodiment, the bend portion 152 defines a bend 160 that is between 120 degrees and 170 degrees, or more particularly about 145 degrees.

The wedge member 156 is disposed on a side of the bend portion 152 facing away from the grip portion. The wedge member 156 extends outwards laterally from the bend portion 152, and is tapered in a direction facing away from the bend portion 152 (See, e.g., FIG. 1). Additionally, the wedge member 156 defines a bottom surface 162. As discussed in further detail below, the wedge member 156 is configured to be wedged between a wheel rim and a tire such that the bottom surface 162 of the wedge member 156 engages with an outer surface of the tire.

The grip portion 154 includes a grip 164 and a shaft portion 163 that extends between the bend portion 152 and the grip 164. The shaft portion 163 has a length such that a user gripping the grip 164 is provided with leverage for acting on the outer surface of the tire via the wedge member 156. In this embodiment, the grip portion 154 is between 12 and 20 inches long, or more particularly, is about 16 inches long, whereby the grip 164 is between 2 and 4 inches long, or more particularly about 3 inches long. As the grip portion 154 is levered toward the tire, the bottom surface 162 of the wedge member 156 pushes against the outer surface of the tire in order to break the bead of the tire from the wheel rim, as discussed in further detail below.

In this embodiment, the end portion 150, bend portion 152, and shaft portion 163 are integral portion of a shaft 166, and the grip 164 is disposed on an end of the shaft portion 163. The shaft 166 can be formed from any acceptable material, and in this embodiment includes a metal material such as steel. The grip 164 can be formed from any acceptable gripping material, such as a metal, a plastic, a rubber, etc. The wedge member 156 can be formed from any acceptable material, and in this embodiment includes a metal material such as steel. In one embodiment, the wedge member 156 is integrally formed with the shaft 166. In another embodiment, the wedge member 156 is attached to the bend portion 152 via a weld, bond, bolt, or any other acceptable attachment technique.

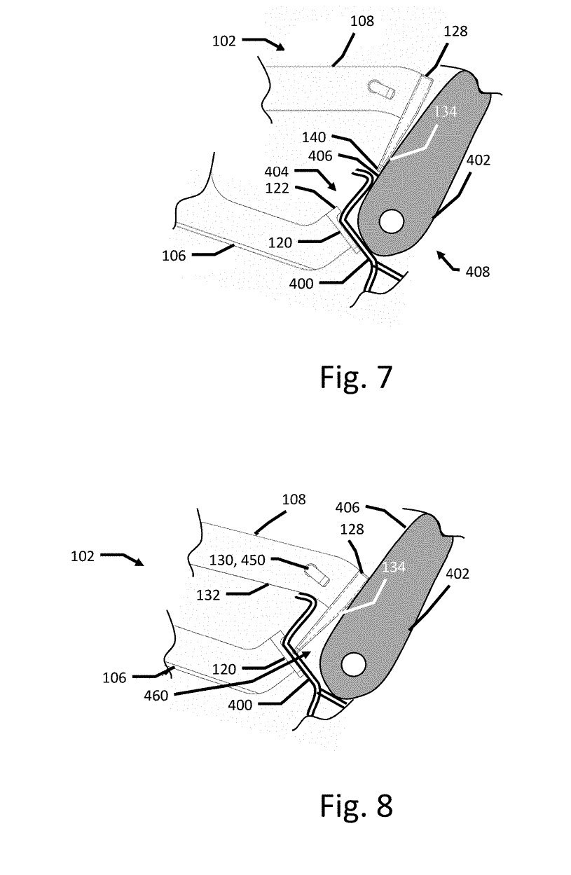

FIG. 6 is an image illustrating the clamping device 102 in use with a wheel rim 400 and tire 402. FIG. 7 illustrates a detail side view of the clamping device 102, wheel rim 400 and tire 402 of FIG. 6. In FIGS. 6 and 7, the clamping device 102 is in an unclamped position. In other words, the first jaw 106 is not clamped together with the second jaw 108. The lip 122 and first plate 120 of the first jaw 106 are engaged with an inboard side 404 of the wheel rim 400 in order to locate the clamping device 102 relative to the wheel rim 400 and tire 402. The second face 134 of the second plate 128 is resting on an outer surface 406 of the tire 402, and the end face 140 of the second plate 128 is oriented toward the bead 408 of the tire 402, i.e., where the outer surface 406 of the tire 402 meets the wheel rim 400.

As the first jaw 106 and second jaw 108 are clamped together, such as via the force of a user gripping the handle portion 105 (FIG. 2) of the clamping device 102, the end face 140 of the second plate 128 is wedged between the wheel rim 400 and the tire 402. FIG. 8 illustrates a side view of the clamping device 102, wheel rim 400, and tire 402 whereat the clamping device 102 is in a clamped position. As the first and second jaws 106 and 108 moved toward each other, the second face 134 of the second plate 128 pushed against the outer surface 406 of the tire 402 and pushed the tire 402 away from the wheel rim 400. The wheel rim 400 is clamped between the first jaw 106 and the second jaw 108. In one embodiment, the inner surface 132 of the second jaw is configured to act as a stop 132 and engage the wheel rim 400 in order to delimit an extent to which the first jaw 106 and second jaw 108 can be clamped together. In another embodiment, the first jaw 106 and second jaw 108 are clamped together until the wheel rim 400 is clamped between the second plate 128 and the first plate 120.

Once the clamping device 102 is clamped onto the wheel rim 400 as illustrated in FIG. 8, the clamping device 102 can be locked in place. Once locked in place, the hook member 130 of the second jaw 108 provides a fixed leverage position 450 for engaging a prying device relative to the wheel rim 400. In one embodiment, once locked, the clamping device 102 is configured to provide the fixed leverage position 450 “hands free,” i.e., such that the clamping device 102 need not be gripped by a user. By pushing the tire 402 away from the wheel rim 402, the second plate 128 causes a gap 460 to be formed between at least a portion of the tire 402 and a portion of the wheel rim 400. Such gap 460 enables a wedge member of a prying device to be wedged between the tire 402 and the wheel rim 400 without a hammering or compression action.

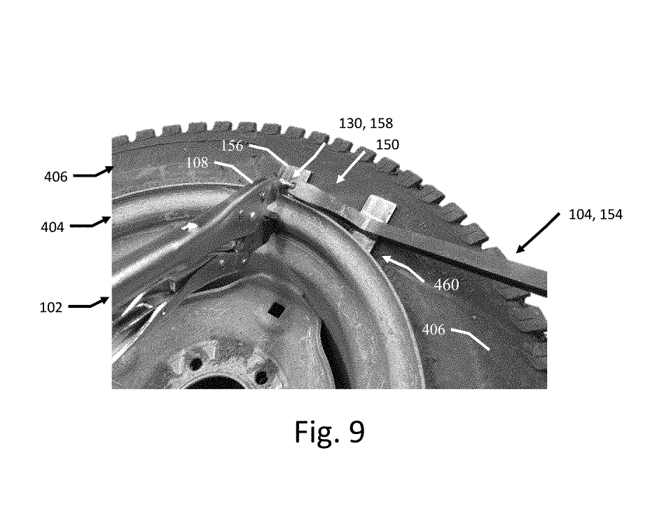

FIG. 9 is an image illustrating the clamping device 102 in the clamped position on the wheel rim 400, and the prying device 104 engaged with the clamping device 102 and with the wheel rim 400 and tire 402. The end portion 150 of the prying device 104 is engaged with the second jaw 108 of the clamping device 102 such that the hook member 130 is at least partially received in the hole 158 in the end portion. The wedge member 156 is wedged between the wheel rim 400 and the tire 402 via a gap 460 between the wheel rim 400 and the tire 402 formed by clamping the first and second jaws 106 and 108 together onto the wheel rim 400. In particular, the gap 460 formed between the wheel rim 400 and the tire 402 enables the wedge member 156 to be inserted manually, i.e., without the aid of a hammering or compression action. Further, since the prying device 104 is engaged with the fixed leverage position 450 of the second jaw 108, the prying device 102 can be manipulated by a user in a reliable fashion with a decreased risk of damage or injury. In other words, the engagement between the prying device 104 and the clamping device 102 restrains the prying device 104 from being moved in ways that risk damage to the tire or wheel rim and injury to the user.

The grip portion 154 of the prying device 104 extends up and away from the outer surface 406 of the tire 400 to provide leverage to a user levering the grip portion 154. As the grip portion 154 is levered toward the tire 402, the wedge member 156 pushes down on the outer surface of the tire 402 to break the bead 408 of the tire 402 from the wheel rim 400.

Different clamping devices and prying devices of different sizes and shapes may be adapted for use for different sizes and types of wheels, wheel rims, and tires. In one embodiment, a kit includes a plurality of different prying devices, a plurality of different clamping devices, or both. In one embodiment, the pluralities of different prying devices and clamping devices each have the same shape and size of hook member and hole, such that clamping devices and prying devices are interchangeable with each other. In another embodiment, the hook member of each clamping device defines a coding that corresponds with a specific hole of a corresponding prying device.

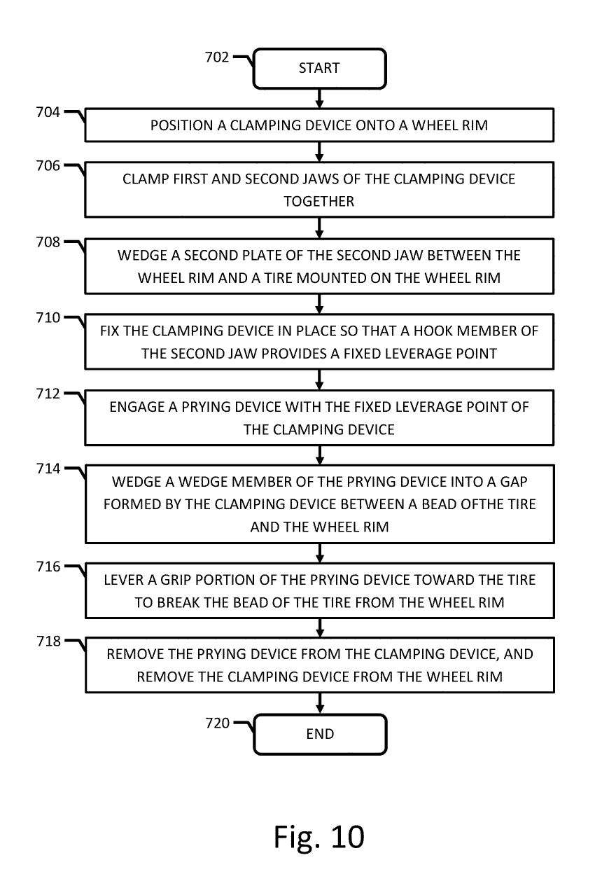

FIG. 10 is a flow diagram that illustrates an exemplary methodology 700 of breaking the bead of a tire from a wheel rim according to this disclosure. The method 700 begins at 702.

At 704, a clamping device is positioned onto a wheel rim. In an embodiment, a lip and a first plate of a first jaw are engaged with an outboard side of the wheel rim in order to locate the clamping device relative to the wheel rim. A second jaw of the clamping device is positioned such that a front side of a second plate on the second jaw is resting on an outer side of the tire, and such that an end side of the second plate facing toward the first plate is oriented toward a location at which the tire meets the wheel rim.

At 706, the first jaw and second jaw of the clamping device are clamped together. In one embodiment, the clamping device is a pair of locking pliers, and the jaws are clamped together via application of force via a user to a handle portion of the locking plies. At 708, as the jaws are clamped together, the second plate of the second jaw is wedged between the tire and the wheel rim to form a gap therebetween. At 710, the clamping device is fixed in place, so that a hook member on the second jaw provides a fixed leverage point.

At 712, a prying device is engaged with the fixed leverage point of the clamping device. In this embodiment, an end portion of the prying device defines a hole. At least a portion of the hook member of the second jaw is received in the hole in order to engage the prying device with the clamping device. At 714, a wedge member of the prying device is wedged into the gap between the tire and the wheel rim formed by the clamping device.

At 716, a grip portion of the prying device opposite the end portion is levered toward the tire so that the wedge portion pushed against the outer surface of the tire to break the bead of the tire from the wheel rim. In this embodiment, the grip portion of the prying device is connected to the end portion via a bend portion such that the grip portion is bent away from the tire when the end portion is engaged with the clamping device by an angle between 120 degrees and 170 degrees, or more particularly about 145 degrees.

In one embodiment, the clamping device can be unlocked, so that the clamping device can be repositioned and locked to another location on the wheel rim, whereby the clamping, wedging, and levering operations can be repeated. Once the bead of tire has been broken from the wheel rim, the prying device is removed from the clamping device, and the clamping device is removed from the wheel rim, at 718. The method ends at 720.

In some embodiments, after the clamping device has been removed, another tool such as a tire spoon can be used in order to unseat the tire with the broken bead from off the wheel rim. In some embodiments, such other tool can be applied before the clamping device has been removed from the wheel room. In some embodiments, the clamping device is further configured to engage with a further tool configured to unseat the tire from the wheel rim. In one embodiment, the prying device 102 defines one end of a tire spoon. In an embodiment, an opposite end of the tire spoon defines a spoon end configured to unseat the tire from the wheel rim.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the disclosure.

What is claimed is:

1. A tool for breaking a bead of a tire from a wheel rim, comprising:
a clamping device that is configured to clamp onto a wheel rim, and that includes:
a hook member,
the hook member positioned on the clamping device such that the hook member is on an outboard side of the wheel rim when the clamping device is clamped onto the wheel rim, and
the hook member defining a hook configured to provide a fixed leverage point for a prying device relative to the wheel rim.

2. The tool according to claim 1, wherein the hook is a convex hook facing toward an operative end of the clamping device.

3. The tool according to claim 1, wherein:
the clamping device further includes:
a first jaw that has a first plate defining a first face configured to engage an outboard side of a wheel rim and locate the clamping device relative to the wheel rim; and
a second jaw that has:
a second plate defining a second face that is transverse to the first face of the first plate and that faces toward an operative end of the clamping device, the second face configured to engage an outer surface of the tire as the first jaw and second jaw are clamped together so that the second jaw is wedged between the tire and wheel rim; and
the hook member is disposed on the second jaw.

4. The tool of claim 3, the second jaw further defining:
an inner surface facing toward the first face of the first plate, the inner surface configured to engage an inboard side of the wheel rim to act as a stop that delimits an extent to which the first jaw and second jaw are able to be clamped together.

5. The tool of claim 3, wherein:
the second plate defines a third face opposite the second face; and
the second face and third face of the second plate taper toward each other in a direction toward the first plate.

6. The tool of claim 3, the clamping device further including:
a material coating over at least a portion of at least one of the first jaw and the second jaw, the material coating configured to deter at least one of scratching the wheel rim and tearing the bead of the tire.

7. The tool of claim 6, wherein the first jaw and the second jaw include a metal material and the material coating includes a rubber material.

8. The tool of claim 3, wherein the first plate includes a lip at an inside end thereof that extends in a direction substantially normal to the first face toward the second jaw, the lip and the first face together configured to receive an edge of the wheel rim to locate the pliers relative to the wheel rim.

9. The tool of claim 1, wherein the clamping device is a pair of locking pliers.

10. The tool of claim 1, further comprising:
a prying device configured to engage the hook member.

11. The tool of claim 10, the prying device including:
an end portion that defines a hole configured to receive the hook member of the clamping device to engage the prying device on the fixed leverage point.
a bend portion that extends out form the end portion;
a grip portion that is connected to the end portion via the bend portion such that the grip portion is bent away from the tire relative to the end portion when the prying device is engaged on the fixed leverage point, and that defines a grip for levering the prying device on the fixed leverage point; and
a wedge member that is disposed on the bend portion and is that configured to wedge between the tire and wheel rim, and push against an outer surface of the tire as the grip portion is levered toward the tire.

12. A tool for breaking a bead of a tire from a wheel rim, comprising:
a prying device that includes:
an end portion configured to engage a fixed leverage point on the wheel rim;
a grip portion that defines a grip for levering the prying device on the fixed leverage point; and
a bend portion that defines a bend that connects the end portion with the grip portion such that the grip portion is bent away from the tire relative to the end portion when the prying device is engaged on the fixed leverage point; and
a wedge member that is disposed on the bend portion and that is configured to wedge between the tire and wheel rim, and push against an outer surface of the tire as the grip portion is levered toward the tire.

13. The tool of claim 12, wherein the end portion defines a hole configured to engage with a hook member of a device clamped onto the wheel rim to provide the fixed leverage point.

14. The tool of claim 12, further comprising:
a clamping device configured to clamp onto the wheel rim and provide the fixed leverage point for the end portion of the prying device.

15. The tool of claim 14, the clamping device including:
a first jaw that has a first plate that defines a first face configured to engage an outboard side of the wheel rim to locate the clamping device relative to the wheel rim; and
a second jaw that has:
a second plate defining a second face that is transverse to the first face of the first plate and that faces toward an operative of the clamping device, the second face configured to engage an outer surface of the tire as the first jaw and second jaw are clamped together so that the second jaw is wedged between the tire and wheel rim; and
a hook member that defines a convex hook facing toward an operative end of the second jaw and that is configured to provide a fixed leverage point for the prying device.

16. A method of breaking a bead of a tire from a wheel rim, comprising:
clamping a first jaw and a second jaw of a clamping device together on a wheel rim to fix the clamping device onto the wheel rim;
engaging a prying device onto a fixed leverage point of the clamping device;
wedging a wedge member of the prying device between a bead of the tire and wheel rim; and
levering the prying device toward the tire so that the wedge portion pushes against an outer surface of the tire to break the bead of the tire from the wheel rim.

17. The method of claim 16, wherein:
the clamping together of the first jaw and second jaw causes the second jaw to be wedged between the tire and the wheel rim; and
the wedge member is wedged into a gap between the tire and wheel rim formed due to the wedging of the second jaw between the tire and the wheel rim.

18. The method of claim 16, wherein:
the clamping device is a pair of locking pliers; and
the method further comprises locking the locking pliers onto the wheel rim to hold the fixed leverage point at a fixed location on the wheel rim.

19. The method of claim 16, wherein;
an end portion of the prying device defines a hole; and
the engaging of the end portion on the hook member of the clamping device includes engaging the end portion with the hook member such that the hook member is at least partially received in the hole.

20. The method of claim 15, wherein:
the prying device includes an end portion configured to engage with the hook member of the clamping device, a grip portion, and a bend portion that connects the grip portion to the end portion such that the grip portion is bent away from the tire as the end portion is engaged with the hook member of the clamping device, the wedge member disposed on the bend portion of the prying device; and
the levering of the prying device includes levering the grip portion toward the tire.
